(19) United States
(12) Patent Application Publication
(10) Pub. No.: US 2026/0077321 A1
(43) Pub. Date: Mar. 19, 2026

(54) METHOD FOR A DYNAMIC IN-LINE MIXING PROCESS

(71) Applicant: Sartorius Stedim Biotech GmbH, Goettingen (DE)

(72) Inventors: Bernhard Diel, Dransfeld (DE); Jan Schaefer, Edermuende (DE)

(21) Appl. No.: 19/108,845

(22) PCT Filed: Sep. 4, 2023
(86) PCT No.: PCT/EP2023/074162

§ 371 Date: Mar. 5, 2025

(30) Foreign Application Priority Data
Sep. 5, 2022 (EP) 22193897.0

(51) Int. Cl. B01F 25/64; B01F 23/50; B01F 25/00; B01F 35/213; B01F 35/83

(52) U.S. Cl. CPC B01F 25/64; B01F 23/51; B01F 23/56; B01F 23/59; B01F 35/213; B01F 35/833; B01F 2025/911; B01F 2025/914; B01F 2025/93

(57) ABSTRACT

A method for the dynamic inline mixing of a pressurized medium containing a liquid and at least one further liquid or solid constituent in a bioprocess arrangement, the liquid being merged with the at least one further liquid or solid constituent in a predefined volume ratio at an opening point to form a resulting liquid flow, the bioprocess arrangement having a pump arrangement with a first pump, the first pump being arranged in the line of the line arrangement, the first pump being designed as a rotary pump configured for the dynamic inline mixing of the medium, the first pump having a liquid inlet, which during intended operation forms the suction side of the pump, and a liquid outlet, which during intended operation forms the pressure side of the pump, and the medium being conducted through the rotary pump for the purpose of dynamic inline mixing.

### CROSS-REFERENCE TO RELATED APPLICATIONS

This application is a national stage application under 35 U.S. C. 371 of International Patent Application Serial No. PCT/EP2023/074162, entitled “METHOD FOR A DYNAMIC IN-LINE MIXING PROCESS,” filed Sep. 4, 2023, which claims priority from European Patent Application No. 22 193 897.0, filed Sep. 5, 2022, the disclosure of which is incorporated herein by reference.

### FIELD OF THE TECHNOLOGY

Various embodiments relate to a method for dynamic inline mixing, to a bioprocess arrangement for dynamic inline mixing, to an electronic process-control means of the proposed bioprocess arrangement, to the use of a rotary pump for implementing a proposed method, to a computer program for the proposed electronic process-control means, and to a computer-readable storage medium for storing the computer program.

### SUMMARY

The method in question for dynamic inline mixing finds application in the context of mixing processes, in particular for mixing buffers and/or media, in a bioprocess, whereby unfavorable storage times in intermediate containers can be avoided.

Here, the term “bioprocess” means biotechnological and biopharmaceutical processes involved in the production of therapeutic bioproducts, such as vaccines, biologics, components for cell or gene therapy, or non-therapeutic bioproducts, such as pigments, biofuels or nutrients. Such bioproducts can either be produced by living cells or the cell itself can constitute the bioproduct or the bioproduct can be the result of cell-free production based on cell components of either natural or non-natural origin.

In the biopharmaceutical industry, disposable technologies are currently on the rise. At the same time, there is a trend toward intensification of processes, as a result of which continuous and semi-continuous process steps are also being implemented more and more frequently. This also applies to mixing processes, in which two or more liquids are mixed together or solids (usually in powder form) are dissolved or suspended in liquids. Currently, the mixing for example of buffers or media, in particular for the fermentation and purification steps, is often carried out batchwise. This involves filling a container with the base liquid to be mixed and then adding (solid or liquid) constituents to be mixed in and performing mixing using a dynamic agitator until the desired degree of mixing or dissolution is achieved, in order to then further process the finished solution.

However, the use of such intermediate containers has the crucial disadvantage that fundamentally sensitive bioproducts, such as an antibody, from bioprocesses can be destroyed on account of an excessively long storage time. In this respect, the storage times of the bioproduct should be kept as short as possible.

For this reason, in various embodiments, mixing processes should not be carried out in intermediate containers, but rather “inline”, meaning within a line of the line arrangement, and therefore currently static mixing elements can be used for inline mixing (US 2017/216791 AA). This is due to the fact that currently interesting disposable concepts for static mixing elements already exist, which can be installed in a simple manner directly in the lines of the bioprocessing system. This is a throughflow system in which the mixing is achieved by virtue of a liquid being conveyed through a line system provided with special geometrical internals, in particular screw elements, paddles and/or pipe wall internals of a wide variety of geometrical shapes. These internals are used to break the flow and to create turbulence and thus to mix the components to be mixed in the throughflow. They can either accommodate two liquid flows to be mixed or mix a single liquid flow.

However, the problem with all static mixers is that, owing to the operating principle, the entire system is dependent on various parameters which can often be controlled only with difficulty. As a result, these systems provide predictable mixing results only if the input parameters, at least including the throughflow rates, the viscosities and the temperatures, of the flows to be mixed are known and can be kept largely constant. Thus, as soon as there is a slight change in the throughflow rates, the dynamic turbulence within the static mixer and therefore the mixing performance also changes. Therefore, such static mixers are often used in branches of industry in which the precision of the mixing process only plays a minor role, for example when mixing two-component adhesives.

However, where processes in which precision in the mixing operation matters are concerned, such as the preparation and mixing of, for example, buffers or media for use in a bioprocess, dynamic inline mixers are currently used in industry. These meet the increasing demands on the mixing performance and the predictability of the mixing process in industry.

The known apparatus and the known method for dynamic inline mixing (WO 2021/133487 A1), from which various embodiments proceed, is used for the dynamic inline mixing of two or more substances, in order to produce a desired concentration or similar of the involved substances, in particular chromatography buffers. The substances are merged at an opening point of a line arrangement to form a resulting liquid flow. Arranged in the line arrangement is a first pump through which the resulting liquid flow is conducted for the purpose of dynamic inline mixing and by which the liquid flow is driven.

As a result, the known apparatus and the known method for dynamic inline mixing provide a critical increase in pressure in the system, which particularly in the case of tube systems can cause problems with respect to the metering accuracy of the liquid flows to be mixed and reproducibility of the mixing result.

Here, “tube system” means the configuration of the at least one line as a tube, such as as a disposable tube, a liquid flow being able to be produced by means of at least one peristaltic pump assigned to the tube, said liquid flow running through the tube.

Various embodiments are based on the problem of designing and developing the known method for dynamic inline mixing in such a way that the mixing performance and the reproducibility of the bioprocess is improved, with a simultaneous increase in the user-friendliness.

The above problem is solved in the case of a method for dynamic inline mixing according to various embodiments provided herein.

What can be essential, in some embodiments, is the fundamental consideration that the method provides a rotary pump, in particular a centrifugal pump, which is arranged in the opposite direction of installation, with the result that the liquid flow flows in the opposite direction through the pump for the purpose of dynamic inline mixing.

The particular design of the proposed method has the advantage that the rotary pump being flowed through counter to the intended direction at least reduces, in particular cancels, the conveying performance of the pump, with the result that a downstream critical increase in pressure can be avoided. In addition, it opens up the possibility of the rotating impeller becoming active as a mixer, which makes it possible to set a variable mixing performance by rotational speed adjustment, such as ensured by a synchronized magnetic pump drive, of the impeller while simultaneously having constant flow conditions (setting of the residence time in the pumping/mixing chamber). If the pump were to be installed in the customary, i.e. intended, direction of installation, it would not be possible to set a desired rotational speed (and thus mixing performance) without also increasing the conveying performance, which would lead to an increase in pressure in the system. Consequently, this is the misuse of a rotary pump, since it is no longer used for conveyance but rather as a resistance unit for generating dynamic turbulence of liquid flows or suspensions.

It is specifically proposed that, for the purpose of dynamic inline mixing, the rotary pump is flowed through in the opposite direction of flow compared with intended operation.

Various embodiments relate to specifications with respect to the opposite direction of installation of the rotary pump. These configurations make it possible in a simple manner to set a desired rotational speed of the rotating shaft and thus mixing performance, but without also increasing the conveying performance, which would lead to an undesired increase in pressure in the system. According to these configurations, the pump body of the rotary pump can be regarded simply as a passage body with an installed agitator.

According to various embodiments, the method provides at least two containers from which the liquid constituent and the at least one further, liquid or solid constituent is delivered into the line arrangement. This configuration enables particular flexibility with respect to the use possibilities of this method. It can for example be used to prepare cultivation media or buffers of all types and is furthermore not limited to exclusively liquid or solid constituents.

According to various embodiments, the pump arrangement has a second and at least a third pump which are configured for metered delivery of liquids and solids. These configurations also emphasize the particular flexibility with respect to the versatile use possibilities of this method.

According to various embodiments, the first pump is designed as a rotary pump, the mixing performance being adjustable by adaptation of at least one parameter of the rotary pump. Moreover, provision may be made for the degree of the adaptation to be derived from a mixing model by an electronic process-control means. These configurations of the advantage that the method is adjustable by an adaptation of the rotational speed of the impeller of the rotary pump and this adjustment can be performed in an automated manner.

According to various embodiments, the electronic process-control means controls at least the valve arrangement and the pump arrangement. Furthermore, provision may be made for the pumps of the pump arrangement to be selectively actuatable by the electronic process-control means, in order to produce predefined setpoint conditions in the resulting liquid flow. This configuration makes it possible to control the proposed method in a particularly precise manner.

According to various embodiments, a sensor arrangement with at least one sensor for generating sensor data relating to the resulting liquid flow is provided, the sensor data representing the actual conditions in the resulting liquid flow at a measurement position and being transmitted to the electronic process-control means. This offers the advantage of checking the obtained mixing performance and the advantage of automated adjustment, on the basis of the measured sensor values.

According to various embodiments, a feedback line is provided. This allows the resulting liquid flow to be mixed again by virtue of the latter being introduced again, and possibly repeatedly, upstream of the rotary pump. The feedback line is selectively activatable when a feedback criterion is satisfied. This enables particularly precise control of the desired mixing performance, even if this was not yet able to be successfully produced after a first mixing operation.

According to various embodiments, the resulting liquid flow downstream of the rotary pump is conducted into at least one downstream unit for the purpose of intermediate storage or further processing. This opens up particular flexibility with respect to the further processing of the mixed liquid flow. This can for example be conducted, for the direct purification thereof, into a downstream chromatography unit or, for the intermediate storage thereof, into an intermediate container.

According to various embodiments, a bioprocess arrangement for the dynamic inline mixing of a pressurized medium containing a liquid and at least one further liquid or solid constituent, in particular of buffers and/or cultivation media, is provided, the liquid being able to be merged with the at least one further liquid or solid constituent in a predefined volume ratio at an opening point to form a resulting liquid flow, the bioprocess arrangement having a line arrangement with at least one line through which the medium to be mixed is conducted, the bioprocess arrangement having a pump arrangement with a first pump, the first pump being arranged in the line of the line arrangement, the first pump being designed as a rotary pump, in particular a centrifugal pump, configured for the dynamic inline mixing of the medium, the first pump having a liquid inlet, which during intended operation forms the suction side of the pump, and a liquid outlet, which during intended operation forms the pressure side of the pump, and the medium being conducted through the rotary pump for the purpose of dynamic inline mixing. In this respect, reference may be made to all the statements regarding the proposed method for dynamic inline mixing.

It is specifically proposed that the rotary pump is arranged in such a way that, for the purpose of dynamic inline mixing, during operation of the bioprocess arrangement, it is flowed through in the opposite direction of flow compared with intended operation.

According to various embodiments, the line arrangement and/or the rotary pump in the bioprocess arrangement are designed as a disposable component. A corresponding exchange of these constituent parts in their entirety, or at least parts thereof, after being used once has the advantage that the sterility is ensured and any cleaning steps after the process has ended are omitted. The rotary pump also offers the advantage that it can be completely assembled prior to use and can be delivered in a sterile manner without the risk of contamination.

According to various embodiments, an electronic process-control means of the proposed bioprocess arrangement is provided. In this respect, reference may be made to all the statements regarding the proposed method for dynamic inline mixing and regarding the proposed bioprocess arrangement.

According to various embodiments, the electronic process-control means has a data processing system for carrying out a proposed method.

According to various embodiments, the use of a rotary pump for implementing a proposed method is provided. In this respect, reference may be made to all the statements regarding the proposed method for dynamic inline mixing, regarding the proposed bioprocess arrangement and regarding the proposed electronic process-control means.

According to various embodiments, a computer program for the proposed electronic process-control means is provided. In this respect, reference may be made to all the statements regarding the proposed method for dynamic inline mixing, regarding the proposed bioprocess arrangement, regarding the proposed electronic process-control means and regarding the proposed use.

According to various embodiments, a computer-readable storage medium for storing the proposed computer program is provided. In this respect, reference may be made to all the statements regarding the proposed method for dynamic inline mixing, regarding the proposed bioprocess arrangement, regarding the proposed electronic process-control means, regarding the proposed use and regarding the proposed computer program.

Various embodiments provide a method for the dynamic inline mixing of a pressurized medium containing a liquid and at least one further liquid or solid constituent, in particular for the inline mixing of buffers and/or cultivation media, in a bioprocess arrangement, the liquid being merged with the at least one further liquid or solid constituent in a predefined volume ratio at an opening point to form a resulting liquid flow, the bioprocess arrangement having a line arrangement with at least one line through which the medium to be mixed is conducted, the bioprocess arrangement having a pump arrangement with a first pump, the first pump being arranged in the line of the line arrangement, the first pump being designed as a rotary pump, in particular a centrifugal pump, configured for the dynamic inline mixing of the medium, the first pump having a liquid inlet, which during intended operation forms the suction side of the pump, and a liquid outlet, which during intended operation forms the pressure side of the pump, and the medium being conducted through the rotary pump for the purpose of dynamic inline mixing, wherein, for the purpose of dynamic inline mixing, the rotary pump is flowed through in the opposite direction of flow compared with intended operation.

In various embodiments, the rotary pump has a rotating shaft which is motor-driven in particular for dynamic inline mixing, such as in such a way that the volume flow of the flow in the flow direction downstream of the pump is smaller than or the same as the volume flow upstream of the pump.

In various embodiments, the rotary pump has an impeller with vanes which in turn have a curved vane surface, and wherein, when the pump is being flowed through, the pressure exerted by the medium to be mixed on the inner side of the curvature is smaller than on the outer side.

In various embodiments, the rotary pump has a pump housing, and wherein the flow out of the pump housing is parallel to the axis of rotation of the impeller. In various embodiments, the flow into the pump housing is at an angle, in particular orthogonal, to the axis of rotation of the impeller.

In various embodiments, the liquid is delivered from a first container, and the at least one further liquid or solid constituent is delivered from at least a second container, into the line arrangement. In various embodiments, the line arrangement has a plurality of lines which are each fluidically connected to an assigned container. In various embodiments, the line arrangement is assigned a valve arrangement with at least one valve for selective fluidic connection of the lines.

In various embodiments, the pump arrangement has a second pump, configured for metered delivery of the liquid, such as from the first container into a line of the line arrangement, and at least a third pump, configured for metered delivery of the respective further liquid or solid constituent, such as from the second container into a second line of the line arrangement.

In various embodiments, at least the second pump and/or third pump, in some embodiments all the pumps which are configured for metered delivery of a liquid flow, are designed as metering pumps. In various embodiments, the respective pump is designed as a peristaltic pump, rotary piston pump or diaphragm pump, and/or wherein at least the third pump, in some embodiments all the pumps which are configured for metered delivery of a solid, are designed as slurry pumps. In various embodiments, the respective pump is designed as a wastewater pump or thick matter pump.

In various embodiments, all the pumps which are configured for dynamic inline mixing of liquids are designed as a rotary pump, such as a centrifugal pump, further such as a disposable centrifugal pump, and/or wherein the first pump, such as all the pumps which are configured for dynamic inline mixing of liquids, is configured to set a desired mixing performance in the resulting liquid flow and the mixing performance is adjustable, in particular in a continuously variable manner, by adaptation of at least one parameter of the at least one rotary pump, such as by adaptation of the rotational speed of the impeller of the rotary pump.

In various embodiments, the bioprocess arrangement has an electronic process-control means. In various embodiments, the electronic process-control means adjusts the at least one parameter of the at least one rotary pump, in particular the rotational speed of the impeller of the rotary pump, and/or wherein the degree of the adaptation of the at least one parameter of the rotary pump, such as the rotational speed of the impeller of the rotary pump, is derived from a mixing model, such as by the electronic process-control means. In various embodiments, the mixing model represents the dependency between the mixing performance and at least one parameter of the rotary pump, such as the rotational speed of the impeller of the rotary pump.

In various embodiments, the electronic process-control means controls at least the valve arrangement and the pump arrangement. In various embodiments, the pumps of the pump arrangement are selectively actuatable by the electronic process-control means, in order to produce predefined setpoint conditions, such as buffer or media conditions, in the resulting liquid flow.

In various embodiments, a sensor arrangement with at least one sensor for generating sensor data relating to the resulting liquid flow is provided, wherein the sensor is arranged downstream of the rotary pump in a line of the line arrangement, wherein the sensor data are transmitted to the electronic process-control means, and wherein the sensor data represent the actual conditions in the resulting liquid flow at a measurement position.

In various embodiments, a feedback line is provided, which branches off downstream of the rotary pump, wherein the feedback line is configured to introduce the resulting liquid flow, for the renewed mixing thereof, upstream of the rotary pump, and wherein the feedback line is selectively activatable, such as by the electronic process-control means, when a feedback criterion is satisfied. In various embodiments, the feedback criterion is satisfied when the actual conditions in the resulting liquid flow that are measured by the sensor fluctuate by more than a predefined value, such as by more than 5% or by more than 10%, and/or deviate from the setpoint conditions.

In various embodiments, the resulting liquid flow downstream of the rotary pump is conducted into at least one downstream unit for the purpose of intermediate storage or further processing.

Various embodiments provide a bioprocess arrangement for the dynamic inline mixing of a pressurized medium containing a liquid and at least one further liquid or solid constituent, in particular of buffers and/or cultivation media, the liquid being able to be merged with the at least one further liquid or solid constituent in a predefined volume ratio at an opening point to form a resulting liquid flow, the bioprocess arrangement having a line arrangement with at least one line through which the medium to be mixed is conducted, the bioprocess arrangement having a pump arrangement with a first pump, the first pump being arranged in the line of the line arrangement, the first pump being designed as a rotary pump, in particular a centrifugal pump, configured for the dynamic inline mixing of the medium, the first pump having a liquid inlet, which during intended operation forms the suction side of the pump, and a liquid outlet, which during intended operation forms the pressure side of the pump, and the medium being conducted through the rotary pump for the purpose of dynamic inline mixing, wherein the rotary pump is arranged in such a way that, for the purpose of dynamic inline mixing, during operation of the bioprocess arrangement, it is flowed through in the opposite direction of flow compared with intended operation.

In various embodiments, the line arrangement and/or the rotary pump is designed as a disposable component, and/or wherein the rotary pump has at least a disposable pump head and/or a disposable pump housing.

Various embodiments provide an electronic process-control means of the bioprocess arrangement as described herein, wherein the line arrangement is assigned a valve arrangement with at least one valve for selective fluidic connection of the lines, and wherein the electronic process-control means is configured to carry out a method as described herein by control of at least the rotary pump, the pump arrangement and/or the valve arrangement. In various embodiments, the electronic process-control means has a data processing system for carrying out a method as described herein.

Various embodiments provide the use of a rotary pump, in particular a centrifugal pump, for implementing a method as described herein. In some embodiments, the constituent parts of the rotary pump that are at least necessary for the intended function, in particular at least including the pump head and the pump housing, form an assembly. In various embodiments, the assembly is designed as a preassembled or single-piece unit which can be designed as a disposable component and/or has a sterile packaging for sterile use.

Various embodiments provide a computer program for the electronic process-control means as described herein.

Various embodiments provide a computer-readable storage medium on which the computer program as provided herein is stored, such as in a non-volatile manner.

### BRIEF DESCRIPTION OF THE DRAWINGS

Various aspects are explained in more detail below with reference to a drawing that merely illustrates exemplary embodiments. In the drawing:

FIG. 1 shows a schematic representation of the proposed method,

FIG. 2 shows an exemplary embodiment of a rotary pump for implementation of the proposed method, and

FIG. 3 shows a schematic representation of the flow through the rotary pump according to

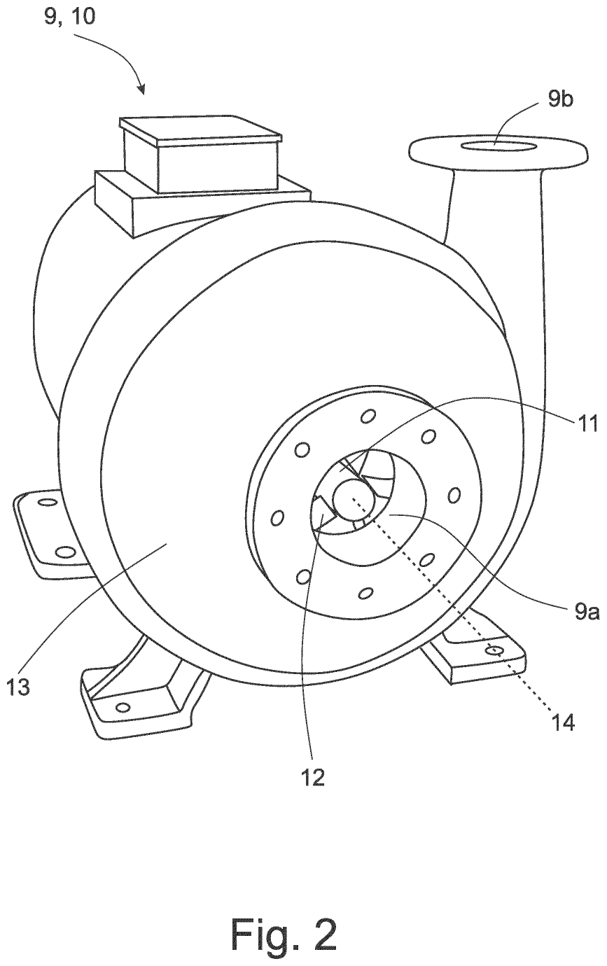

FIG. 2 during operation.

### DETAILED DESCRIPTION

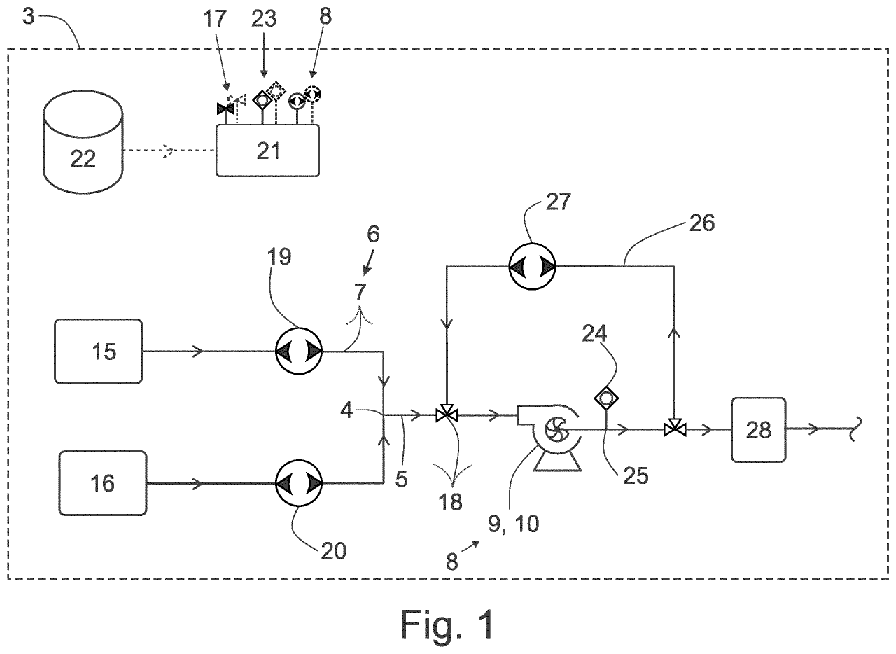

FIG. 1 illustrates a method for the dynamic inline mixing of a pressurized medium 1. This is used in the production and/or quality control of biopharmaceutical products, such as during the production of a protein by means of a bioprocess. Such proteins may for example be growth factors, hormones, enzymes and in particular antibodies, antibody derivatives or the like. The proposed method can be used to ensure that a pressurized medium 1 containing a liquid and at least one further liquid or solid constituent is mixed dynamically and inline. The method is used in particular for the inline mixing of biotechnological media 2, such as buffers and/or cultivation media or the like, in a bioprocess arrangement 3.

The liquid is merged with the at least one further liquid or solid constituent in a predefined volume ratio at an opening point 4 to form a resulting liquid flow 5.

Here, “predefined volume ratio” means that the volume ratio of the liquid and/or solids volumes forming the medium 1 has already been defined before the proposed method is carried out or has been adapted during the proposed use of the method. In various embodiments, the volume ratio of the liquid and/or solids volumes forming the medium 1 are defined and/or adapted by the user. A possible adaptation can be effected on the basis of measured parameters, as will be described below, as a result of which reactive control of the volume ratio is made possible.

The bioprocess arrangement 3 has a line arrangement 6 with at least one line 7 through which the medium 1 to be mixed or the constituent parts to be mixed together is/are conducted. Furthermore, the bioprocess arrangement 3 has a pump arrangement 8 with a first pump 9, the first pump 9 being arranged in the line 7 of the line arrangement 6. The first pump 9 is designed as a rotary pump 10, in particular a centrifugal pump, and configured for the dynamic inline mixing of the medium 1. The first pump 9 has a liquid inlet 9a, which in the intended direction of flow forms the suction side of the pump 9, and a liquid outlet 9b, which during intended operation forms the pressure side of the pump. For the purpose of dynamic inline mixing, the medium 1 is conducted through the first pump 9 designed as a rotary pump 10.

Here, the term “intended” accordingly means the purpose that the manufacturer intends for the pump 9. In the present case, “intended direction of flow” consequently means the direction of flow for the pump 9 as intended by the manufacturer.

Here, “medium” very generally means a liquid, a liquid mixture or a suspension which consists of a liquid and at least one further liquid or solid constituent. Within the meaning of the present patent application, a medium 1 may be a biotechnological medium 2, such as a buffer and/or a cultivation medium, in a bioprocess arrangement 3. It is also conceivable for the liquid and/or the at least one further liquid or solid constituent of the medium 1 or the medium 1 as such to be able to be a concentrate, such as a product flow or a protein product flow, and/or a solvent, in particular water, ethanol, acid or base or the like. Consequently, the proposed method is usable in a versatile manner and can be used not only for mixing or diluting buffers and/or cultivating media but also for example for a method for virus inactivation in a bioprocess.

Here, the term “dynamically” means a mixer with a dynamic mixing performance, the mixing performance changing in dependence on at least one settable parameter, in particular in dependence on an agitator rotational speed.

Here, the term “inline”means within a line 7 of the line arrangement 6.

It is then essential in the proposed method that, for the purpose of dynamic inline mixing, the rotary pump 10 is flowed through in the opposite direction of flow compared with intended operation.

In various embodiments, it is the case, as shown in FIG. 2, that the rotary pump 10 has a rotating shaft 11, in particular for driving an impeller 12 with vanes, which is in particular motor-driven for dynamic inline mixing. In various embodiments, the rotating shaft 11 is driven in such a way that the volume flow of the flow in the flow direction downstream of the pump 9 is smaller than or the same as the volume flow upstream of the pump 9. This makes it possible for the rotary pump 10 to be able to become active as a mixer, a variable mixing performance ultimately being enabled by rotational speed adjustment of the rotating shaft 11.

Here, the term “rotational speed adjustment” means an external rotational speed adjustment of the rotating shaft 11 and for instance not a rotational speed adjustment by the flow itself. Consequently, it is a rotational speed adjustment of the rotating shaft 11 by virtue of said shaft being influenced, in particular braked or accelerated, outside of the flow.

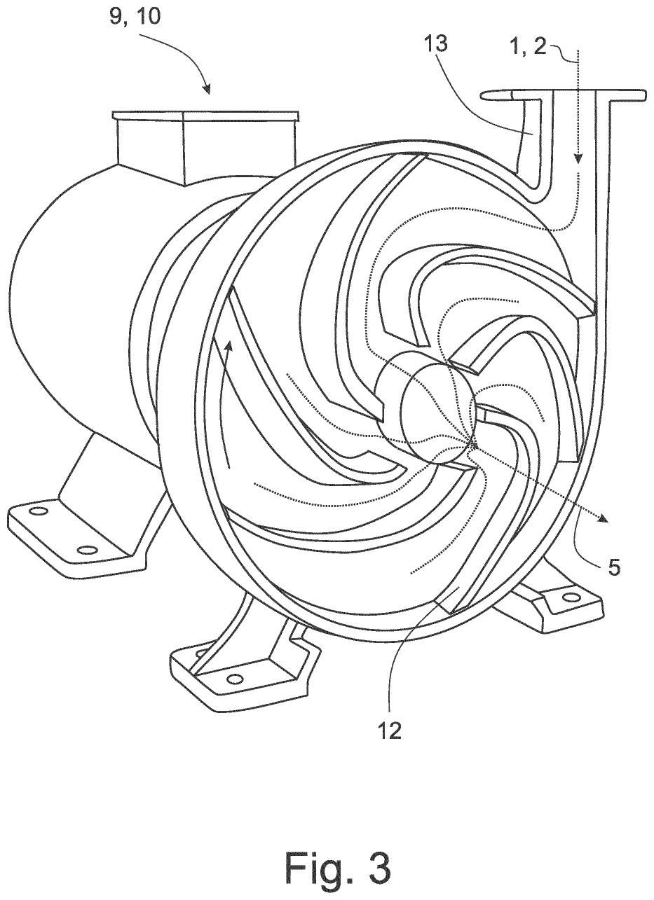

In various embodiments, the rotary pump 10 has an impeller 12 with vanes which in turn have a curved vane surface, as illustrated in FIG. 3. When the rotary pump 10 is being flowed through, the pressure exerted by the medium 1 to be mixed on the inner side of the curvature of the vane surfaces can be smaller than on the outer side of the vane surfaces. The flow conditions, such as flow rate, volume flow, liquid pressure or the like, can thus remain constant, with the result that a critical increase in pressure does not have to be accepted. In the event of the use of such an impeller 12, given the proposed opposite flow through the rotary pump 10, the direction of rotation of the impeller 12 can also correspond to the direction of flow of the resulting liquid flow 5. Otherwise, the rotation of the impeller 12 would work against the flow of the resulting liquid flow 5 and would consequently impede it when flowing through the rotary pump 10. However, even if the direction of rotation of the impeller 12 runs counter to the direction of flow of the resulting liquid flow 5, the conveying performance of the rotary pump 10, which would result in a critical increase in pressure, will still be reduced, possibly even canceled, as desired. In some embodiments, the opposite direction of rotation of the impeller 12 of the rotary pump 10 can be able to be realized by corresponding wiring, such as by phase reversal.

It should particularly be noted at this point that the effect of various embodiments, that of a variable mixing performance being settable by rotational speed adjustment of the impeller 12 while simultaneously having constant flow conditions, without having to accept a critical increase in pressure, would not be able to be realized by a simple reversal of the direction of rotation of the impeller 12 of the rotary pump 10. In fact, a pump which is arranged in the intended direction of installation and the impeller 12 of which rotates in the opposite direction would still pump in the same, intended direction, although the efficiency of the pump would be restricted considerably, the throughflow would be reduced and the noise development would be increased. The conveying action would remain at least partially unchanged, with the result that an undesired increase in pressure would then also occur.

As illustrated in FIG. 3, in various embodiments, the rotary pump 10 has a pump housing 13. The flow out of the pump housing 13 is parallel to the axis of rotation of the impeller 14 (FIG. 2). In various embodiments, the flow into the pump housing 13 is at an angle, such as orthogonal, to the axis of rotation of the impeller 14.

As illustrated in FIG. 1, the liquid can be delivered from a first container 15, and the at least one further liquid or solid constituent is delivered from at least a second container 16, into the line arrangement 6. The line arrangement 6 may have a plurality of lines 7 which are each fluidically connected to an assigned container 15, 16. In various embodiments, it is the case that the line arrangement 6 is assigned a valve arrangement 17 with at least one valve 18, configured for selective fluidic connection of the lines 7.

In various embodiments, the pump arrangement 8 has a second pump 19, configured for metered delivery of the liquid, such as from the first container 15 into a line 7 of the line arrangement 6. Furthermore, the pump arrangement 8 has at least a third pump 20, configured for metered delivery of the respective further liquid or solid constituent, such as from the second container 16 into a second line 7 of the line arrangement 6 (FIG. 1).

Furthermore, at least the second and/or third pump 19, 20, and in various embodiments all the pumps which are configured for metered delivery of a liquid flow, may be designed as a metering pump, in particular as a peristaltic pump, rotary piston pump or diaphragm pump. In addition or as an alternative, at least the third pump 20, and in various embodiments all the pumps which are configured for metered delivery of a solid, may be designed as a slurry pump, such as a wastewater pump or thick matter pump.

In various embodiments, all the pumps which are configured for the dynamic inline mixing of liquids are designed as a rotary pump 10, such as a centrifugal pump or a disposable centrifugal pump. In addition or as an alternative, the first pump 9 is, and in various embodiments all the pumps which are configured for the dynamic inline mixing of liquids are, configured to set a desired mixing performance in the resulting liquid flow 5. The mixing performance can be adjustable, in particular in a continuously variable manner, by adaptation of at least one parameter of the at least one rotary pump 10, such as by adaptation of the rotational speed of the impeller 12 of the rotary pump 10. In various embodiments, the bioprocess arrangement 3 has an electronic process-control means 21 which adjusts the at least one parameter of the at least one rotary pump 10, in particular the rotational speed of the impeller 12 of the rotary pump 10. Also in addition or as an alternative, the degree of the adaptation of the at least one parameter of the rotary pump 10, such as the rotational speed of the impeller 12 of the rotary pump 10, is derived from a mixing model 22, such as by the electronic process-control means 21 (see FIG. 1). In various embodiments, the mixing model 22 represents the dependency between the mixing performance and the at least one parameter of the rotary pump 10, such as the rotational speed of the impeller 12 of the rotary pump 10.

That electronic process-control means 21 controls at least the valve arrangement 17 and the pump arrangement 8. The pumps of the pump arrangement 8 can be selectively actuatable by the electronic process-control means 21, in order to produce predefined setpoint conditions in the resulting liquid flow 5. The setpoint conditions can be buffer or media conditions, for example a specific pH, the concentration of at least one substance, the conductivity or the like.

In various embodiments, in the proposed method, as illustrated in FIG. 1, a sensor arrangement 23 with at least one sensor 24, in particular a pH, conductivity, flow or concentration sensor or the like, for generating sensor data relating to the resulting liquid flow 5 is provided. In various embodiments, the sensor 24 is arranged downstream of the rotary pump 10 in a line 7 of the line arrangement 6. In various embodiments, the sensor data, which represent the actual conditions in the resulting liquid flow 5 at a measurement position 25, are transmitted to the electronic process-control means 21. In addition or as an alternative, the sensor data may feed into and/or be used in the mixing model 22, such as by the electronic process-control means 21, in order to evaluate the mixing performance in the resulting liquid flow 5.

As can be seen in FIG. 1, a feedback line 26 is provided, which branches off downstream of the rotary pump 10. This feedback line 26 is configured to introduce the resulting liquid flow 5, for the renewed mixing thereof, upstream of the rotary pump 10 and is selectively activatable, such as by the electronic process-control means 21, when a feedback criterion is satisfied. In various embodiments, the feedback line 26 has a fourth pump 27, in order to introduce the resulting liquid flow 5, for the renewed mixing thereof, upstream of the rotary pump 10 (FIG. 1). The feedback criterion can be satisfied when the actual conditions in the resulting liquid flow 5 that are measured by the sensor 24 fluctuate by more than a predefined value, such as by more than 5% or by more than 10%, and/or deviate from the setpoint conditions.

If, for example, a concentration desired by the user has still not been achieved, with the result that the parameter measured by the at least one sensor 24 deviates by more than a predefined value, the resulting liquid flow 5 can be introduced, for the renewed mixing thereof, upstream of the rotary pump 10, such as until the resulting liquid flow 5 exhibits the desired setpoint conditions. Moreover, provision may be made for the feedback line 26 to be configured for feedback control.

Here, the term “feedback control” means the self-adjustment of the activity of the system, in particular with respect to the rotational speed of the impeller 12 of the rotary pump 10, on the basis of sensor data measured by means of at least one sensor 24 which is connected for data communication purposes.

In various embodiments, in the state mounted as intended, the resulting liquid flow 5 downstream of the rotary pump 10 is conducted into at least one downstream unit 28 for the purpose of intermediate storage or further processing (FIG. 1). This downstream unit 28 can be an intermediate container for the intermediate storage of the resulting liquid flow 5. In the event of intermediate storage, it may for example be intended that a specific minimum setpoint volume has built up in the intermediate container, before it is further processed.

As an alternative, this downstream unit 28 can be a processing unit from the group including a filter unit, a chromatography unit, a virus filtration unit or the like. Moreover, provision may be made for the resulting liquid flow 5 to initially be conducted into an intermediate container for intermediate storage and to be conducted into at least one processing unit for further processing after a predefined, such as user-defined, time has elapsed.

According to a further teaching, which is of independent significance, a bioprocess arrangement 3 for the dynamic inline mixing of a pressurized medium 1 containing a liquid and at least one further liquid or solid constituent, in particular of buffers and/or cultivation media, is provided. The liquid is merged with the at least one further liquid or solid constituent in a predefined volume ratio at an opening point 4 to form a resulting liquid flow 5. The bioprocess arrangement 3 has a line arrangement 6 with at least one line 7 through which the medium 1 to be mixed is conducted. Furthermore, the bioprocess arrangement 3 has a pump arrangement 8 with a first pump 9, the first pump 9 being arranged in the line 7 of the line arrangement 6. The first pump 9 is designed as a rotary pump 10, in particular a centrifugal pump, and configured for the dynamic inline mixing of the medium 1. The first pump 9 has a liquid inlet 9a, which during intended operation forms the suction side of the pump, and a liquid outlet 9b, which during intended operation forms the pressure side of the pump, the medium 1 being conducted through the rotary pump 10 for the purpose of dynamic inline mixing. In this respect, reference may be made to all the statements regarding the proposed method.

It is then essential in the proposed bioprocess arrangement 3 that the rotary pump 10 is arranged in such a way that, for the purpose of dynamic inline mixing, during operation of the bioprocess arrangement 3, it is flowed through in the opposite direction of flow compared with intended operation.

In various embodiments, the line arrangement 6 and/or the rotary pump 10 is designed as a disposable component. In addition or as an alternative, the rotary pump 10 has at least a disposable pump head and/or a disposable pump housing. The proposed method therefore provides for the use of a rotary pump 10, such as a centrifugal pump or a disposable centrifugal pump, for inline mixing in the opposite (incorrect) direction of installation, said pump in some embodiments being completely assembled prior to use and being delivered in a sterile manner without the risk of contamination.

According to various embodiments, an electronic process-control means of the proposed bioprocess arrangement is provided. In this respect, reference may be made to all the statements regarding the proposed method for dynamic inline mixing and regarding the proposed bioprocess arrangement.

According to various embodiments, the electronic process-control means has a data processing system for carrying out a proposed method.

According to various embodiments, the use of a rotary pump for implementing a proposed method is provided. In this respect, reference may be made to all the statements regarding the proposed method for dynamic inline mixing, regarding the proposed bioprocess arrangement and regarding the proposed electronic process-control means.

According to various embodiments, a computer program for the proposed electronic process-control means is provided. In this respect, reference may be made to all the statements regarding the proposed method for dynamic inline mixing, regarding the proposed bioprocess arrangement, regarding the proposed electronic process-control means and regarding the proposed use.

According to various embodiments, a computer-readable storage medium for storing the proposed computer program is provided. In this respect, reference may be made to all the statements regarding the proposed method for dynamic inline mixing, regarding the proposed bioprocess arrangement, regarding the proposed electronic process-control means, regarding the proposed use and regarding the proposed computer program.

1. A method for the dynamic inline mixing of a pressurized medium containing a liquid and at least one further liquid or solid constituent, in particular for the inline mixing of buffers and/or cultivation media, in a bioprocess arrangement, the liquid being merged with the at least one further liquid or solid constituent in a predefined volume ratio at an opening point to form a resulting liquid flow, the bioprocess arrangement having a line arrangement with at least one line through which the medium to be mixed is conducted, the bioprocess arrangement having a pump arrangement with a first pump, the first pump being arranged in the line of the line arrangement, the first pump being designed as a rotary pump configured for the dynamic inline mixing of the medium, the first pump having a liquid inlet which during intended operation forms the suction side of the pump, and a liquid outlet, which during intended operation forms the pressure side of the pump, and the medium being conducted through the rotary pump for the purpose of dynamic inline mixing,
wherein, for the purpose of dynamic inline mixing, the rotary pump is flowed through in the opposite direction of flow compared with intended operation.

2. The method as claimed in claim 1, wherein the rotary pump has a rotating shaft which is motor-driven for dynamic inline mixing.

3. The method as claimed in claim 1, wherein the rotary pump has an impeller with vanes which in turn have a curved vane surface, and wherein, when the pump is being flowed through, the pressure exerted by the medium to be mixed on the inner side of the curvature is smaller than on the outer side.

4. The method as claimed in claim 1, wherein the rotary pump has a pump housing and wherein the flow out of the pump housing is parallel to the axis of rotation of the impeller.

5. The method as claimed in claim 1, wherein the liquid is delivered from a first container, and the at least one further liquid or solid constituent is delivered from at least a second container, into the line arrangement.

6. The method as claimed in claim 1, wherein the pump arrangement has a second pump, configured for metered delivery of the liquid, and at least a third pump, configured for metered delivery of the respective further liquid or solid constituent.

7. The method as claimed in claim 6, wherein at least the second pump and/or third pump, are designed as metering pumps, designed and/or wherein at least the third pump is designed as a slurry pump.

8. The method as claimed in claim 1, wherein all the pumps which are configured for dynamic inline mixing of liquids are designed as a rotary pump and/or wherein the first pump is configured to set a desired mixing performance in the resulting liquid flow and the mixing performance is adjustable by adaptation of at least one parameter of the at least one rotary pump, and/or wherein the degree of the adaptation of the at least one parameter of the rotary pump is derived from a mixing model.

9. The method as claimed in claim 5, or wherein the electronic process-control means controls at least the valve arrangement and the pump arrangement in order to produce predefined setpoint conditions in the resulting liquid flow.

10. The method as claimed in claim 1, wherein a sensor arrangement with at least one sensor for generating sensor data relating to the resulting liquid flow is provided, wherein the sensor is arranged downstream of the rotary pump in a line of the line arrangement, wherein the sensor data are transmitted to the electronic process-control means, and wherein the sensor data represent the actual conditions in the resulting liquid flow at a measurement position.

11. The method as claimed in claim 1, wherein a feedback line is provided, which branches off downstream of the rotary pump, wherein the feedback line is configured to introduce the resulting liquid flow, for the renewed mixing thereof, upstream of the rotary pump, and wherein the feedback line is selectively activatable, when a feedback criterion is satisfied.

12. The method as claimed in claim 1, wherein the resulting liquid flow downstream of the rotary pump is conducted into at least one downstream unit for the purpose of intermediate storage or further processing.

13. A bioprocess arrangement for the dynamic inline mixing of a pressurized medium containing a liquid and at least one further liquid or solid constituent, the liquid being able to be merged with the at least one further liquid or solid constituent in a predefined volume ratio at an opening point to form a resulting liquid flow, the bioprocess arrangement having a line arrangement with at least one line through which the medium to be mixed is conducted, the bioprocess arrangement having a pump arrangement with a first pump, the first pump being arranged in the line of the line arrangement, the first pump being designed as a rotary pump, configured for the dynamic inline mixing of the medium, the first pump having a liquid inlet which during intended operation forms the suction side of the pump, and a liquid outlet which during intended operation forms the pressure side of the pump, and the medium being conducted through the rotary pump for the purpose of dynamic inline mixing,
wherein the rotary pump is arranged in such a way that, for the purpose of dynamic inline mixing, during operation of the bioprocess arrangement, it is flowed through in the opposite direction of flow compared with intended operation.

14. The bioprocess arrangement as claimed in claim 13, wherein the line arrangement and/or the rotary pump is designed as a disposable component, and/or wherein the rotary pump has at least a disposable pump head and/or a disposable pump housing.

15. An electronic process-control means of the bioprocess arrangement as claimed in claim 13, wherein the line arrangement is assigned a valve arrangement with at least one valve for selective fluidic connection of the lines, and wherein the electronic process-control means is configured to carry out a method-as by control of at least the rotary pump the pump arrangement and/or the valve arrangement.

16. The electronic process-control means as claimed in claim 15, wherein the electronic process-control means has a data processing system for carrying out a method.

17. The use of a rotary pump, for implementing a method as claimed in claim 1, wherein the constituent parts of the rotary pump that are at least necessary for the intended function.

18. A computer program for the electronic process-control means as claimed in claim 15.

19. A computer-readable storage medium on which the computer program as claimed in claim 18 is stored, in a non-volatile manner.

20. The method as claimed in claim 1, wherein the rotary pump has a rotating shaft which is motor-driven for dynamic inline mixing, in such a way that the volume flow of the flow in the flow direction downstream of the pump is smaller than or the same as the volume flow upstream of the pump.
